(19) United States
(12) Patent Application Publication
(10) Pub. No.: US 2023/0376728 A1
(43) Pub. Date: Nov. 23, 2023

(54) PROXY SYSTEMS AND METHODS FOR MULTIPROCESSING ARCHITECTURES

(71) Applicant: Kinara, Inc., Los Altos, CA (US)

(72) Inventors: Lava Kumar Bokam, Hyderabad (IN); Sriduth Jayhari, Hyderabad (IN); Divya Vipin, Hyderabad (IN); Rajashekar Reddy Ereddy, Hyderabad (IN); Snigdha Alkanti, Medak (IN); Venkateswara Rao Andole Mankali, Hyderabad (IN); Suresh Kumar Vennam, Hyderabad (IN); Mohammed Mujahid, Hyderabad (IN); Sreenivas Aerra Reddy, San Jose, CA (US)

(21) Appl. No.: 18/318,841

(22) Filed: May 17, 2023

Related U.S. Application Data
(60) Provisional application No. 63/343,014, filed on May 17, 2022.

(51) Int. Cl. G06N 3/045

(52) U.S. Cl. CPC G06N 3/045

(57) ABSTRACT

Proxy systems and methods for multiprocessing architectures are described. One method includes receiving a neural network model from a client computing system. System resource availability on a plurality of processing devices may be assessed, and a subset of available processing devices may be selected based on the system resource availability. In one aspect, the neural network model is loaded into each processing device in the subset. The method may include receiving an inference request from the client computing system. A load state of each processing device in the subset may be accessed, and a target processing device from the subset may be selected based on the load states. The inference request may be transmitted to the target processing device.

### RELATED APPLICATION

This application claims the priority benefit of U.S. Provisional Application Ser. No. 63/343,014, entitled “SYSTEMS AND METHODS FOR MANAGING MULTIPLE MACHINE-LEARNING-SPECIFIC PROCESSORS,” filed May 17, 2022, the disclosure of which is incorporated by reference herein in its entirety.

### BACKGROUND

### Technical Field

The present disclosure relates to systems and methods that map at least one client computing system and associated inference requests to one or more processing devices included in a plurality of processing devices.

### Background Art

Recent developments in artificial intelligence/machine learning technologies as well as processing technology have resulted in an increasing number of system architectures where a plurality of processing devices are configured to execute one or more inference requests from one or more client computing systems. For a multi-client/multiprocessor device mapping/architecture it can be a challenge to monitor, manage, and allocate system resources on both the client computing system side and the processing device side.

### SUMMARY

Aspects of the invention are directed to systems and methods for implementing a proxy computing system for multiprocessing architectures. One method includes a proxy computing system receiving a neural network model from a client computing system. The proxy computing system may access system resource availability on a plurality of processing devices, and select a subset of available processing devices based on the system resource availability. The proxy computing system may load the neural network model into each processing device in the subset.

In one aspect, the proxy computing system receives an inference request from the client computing system. In response, the proxy computing system accesses a load state of each processing device in the subset, and selects a target processing device from the subset based on the load states. The proxy computing system may transmit the inference request to the target processing device.

Other aspects include apparatuses that implement the workflows associated with the above method.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a proxy computing system interface.

FIG. 2 is a block diagram depicting a request management workflow by a proxy computing system.

FIGS. 3A, 3B, 3C, 3D, and 3E are block diagrams depicting an inference request/response workflow.

FIGS. 4A, 4B, 4C, 4D, and 4E are block diagrams depicting an inference request/response workflow.

FIGS. 5A, 5B, and 5C are block diagrams depicting an inference request/response workflow.

FIG. 6 is a workflow diagram depicting a workflow for generating a model load response.

FIG. 7 is a workflow diagram depicting a workflow for generating an inference response.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention are directed to systems and methods for implementing an interface between one or more client computing systems and a plurality of processing units (i.e., processing devices). In one aspect, a proxy computing system implements such an interface. Such a proxy computing system may enable a client computing device to communicate with one or more processing units. Proxy computing system may also facilitate allocating or mapping one or more inference requests from the client computing systems to the processing units. Any inference results generated by the processing units may be routed back to the client computing system that initiated the corresponding inference requests.

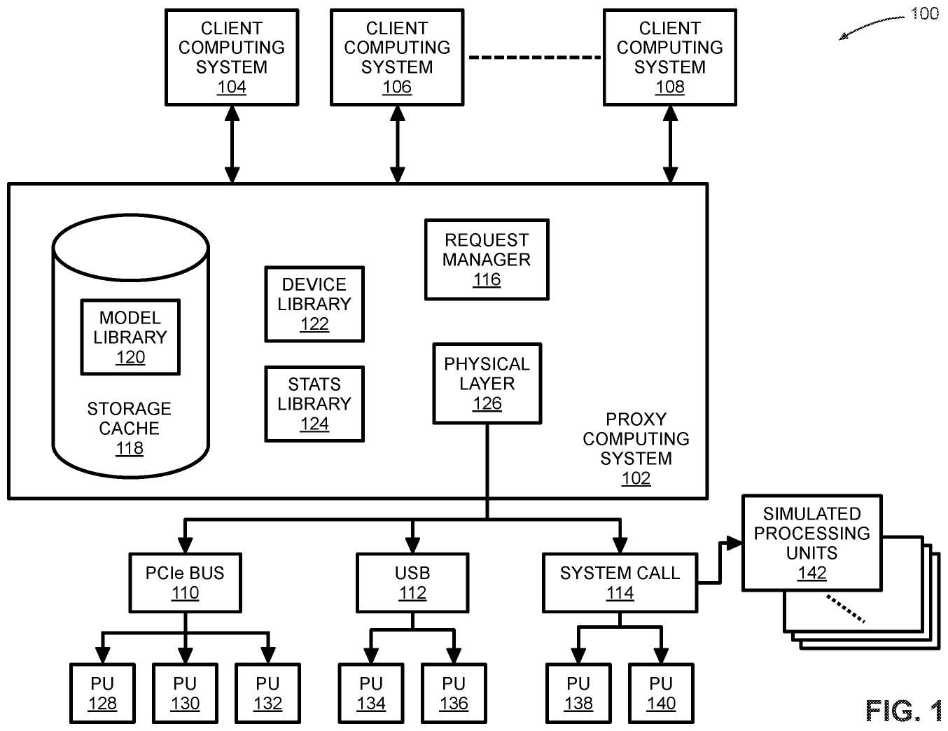

FIG. 1 is a block diagram depicting a proxy computing system interface 100. As depicted, proxy computing system interface 100 includes proxy computing system 102, client computing system 104, 106 through 108, PCIe bus interface 110, USB interface 112, system call interface 114, processing units 128, 130, 132, 134, 136, 138 and 140, and simulated processing units 142. Proxy computing system 102 further includes storage cache 118, device library 122, stats library 124, request manager 116, and physical layer 126. Storage cache 118 further includes model library 120.

In one aspect, each of client computing system 104 through 108 is a computing system including at least a processor, a memory, and a network interface. Each of client computing system 104 through 108 may run an operating system (e.g., Linux, Windows, MacOS, Unix, etc.). Examples of computing systems include desktop computers, laptop computers, mobile computing devices such as tablets and smartphones, and so on.

In one aspect, each of processing units (PU) 128 through 140 (also described as a “processing device”) is a standalone computing unit that includes at least a processor, memory, and a network interface. Examples of processing devices include single-board standalone computing systems (e.g., ARM-based computing systems and other kinds of embedded processing systems). In one aspect, each of PU 128 through 140 are configured to be loaded with one or more neural network models. These neural network models may be loaded onto any combination of PU 128 through PU 140 by proxy computing system 102, from model library 120 stored in storage cache 118. Each of PU 128 through PU 140 may be configured to run one or more inference requests associated with a particular neural network model running on the respective PU. These inference requests may be received from any of client computing systems 104 through 108 and routed to the appropriate PU via proxy computing system 102. The associated PU may run the inference request, and generate an inference result. The inference result may be routed back to the client computing system that originated the inference request, by proxy computing system 102.

In one aspect proxy computing system 102 interfaces with one or more PUs via interfaces such as PCIe bus 110 (used to interface proxy computing system 102 with Pus 128, 130 and 132), USB interface 112 (used to interface proxy computing system 102 with Pus 134 and 136), and one or more system calls 114 (used to interface proxy computing system 102 with Pus 138 and 140). Interfaces PCIe bus 110, USB 112, and system call 114 may be implemented and generated by physical layer 126, and enable proxy computing system 102 to interface with PUs 128 through 140 via the appropriate communication protocol. Other interfaces such as an inter-process communication (IPC) interface (not depicted in FIG. 1) may be used to interface proxy computing system with one or more PUs.

Device library 122 may be used by proxy computing system 102 to appropriately interface with a PU. Device library 122 may include information about each device associated with a PU. For example, if a PU is a computing board, data associated with the PU as stored in device library 122 may include processor type (e.g., ARM processor, GPU), number of compute cores, system RAM, processing unit memory states, model occupancy for each PU, etc. Proxy computing system 102 may be interfaced with client computing systems 104 through 108 via interfaces such as USB, Ethernet, Wi-Fi, Bluetooth, ZigBee, or any other connectivity protocol.

In one aspect, proxy computing system 102 receives a model load request from any combination of client computing system 104 through client computing system 108. For example, proxy computing system 102 may receive a model load request from client computing system 104. A model load request may be a request to load a neural network model onto a PU (e.g., PU 128). Proxy computing system 102 may retrieve an appropriate model from model library stored on storage cache 118, and load the model onto one or more appropriate PUs via the associated interface.

In one aspect, proxy computing system 102 may receive an inference request from any of client computing systems 104 through 108. An inference request may be a request to run an inferencing operation on a specific neural network model running on any of PUs 128 through 140 that have been previously loaded with the neural network model. Based on available resources on PUs 128 through 140 (as determined by proxy computing system 102 using, for example, device library 122 and stats library 124), proxy computing system 102 may select a PU on which to run the inference request. Request manager 116 may be configured to route the inference request to the selected PU via physical layer 126, and the relevant communication interface (e.g., PCIe bus 110, USB 112, or system call 114). The selected PU may run the inference request and generate an inference output (or inference result). The inference output/result may be transmitted to proxy computing system 102 via the relevant communication interface. Proxy computing system 102 may transmit the inference output to the client computing system that generated the inference request.

In one aspect, a client computing system may wish to run a simulation for an inference request, rather than running the inference request on a PU. Such a scenario may be used if a developer working on the client computing system is in the process of developing or debugging software code associated with the inference request. In this case, proxy computing system 102 may route the inference request to simulated processing units 142. Simulated processing units 142 may execute the associated inference request, and transmit simulated inferencing results back to the client computing system via proxy computing system 102.

In one aspect, simulated processing units 142 are built using C++ or any other applicable programming language. Simulated processing units 142 may be used in case hardware is not ready (e.g., not yet manufactured). Simulated processing units 142 may also be used when greater observability is needed, which a hardware may not be able to provide (e.g., debugging an FPGA-class device). In one aspect, simulated processing units 142 include one or more simulation models that represent a device behavior associated with the simulated device. Such models may be of various different capabilities, or may abstract a system (e.g., a PU), depending on project requirements. For example, a model of a processor may choose to mimic arithmetic computations in fine detail while choosing to be less thorough or detailed in modeling memory hierarchy. In this case, the model may model a flat memory hierarchy instead of L1, L2, L3, DRAM levels.

In essence, proxy computing system 102 functions as a transparent interface (i.e., a proxy) between client computing system 104 through 108, and PUs 128 through 140 and simulated processing units 142. A client computing system may wish to load a preferred neural network model onto a PU. In this case, proxy computing system 102 selects one or more available/compatible PUs, and loads the neural network model onto the PUs. The client computing system may then request that an inferencing request be run using the preferred neural network model. Proxy computing system 102 may select a PU among the PUs running the preferred neural network model, that has sufficient computing resources available, and load the inference request onto that PU. The PU may run the inference request, and generate inference results. The inference results are then transmitted back to the client computing system that originated the inference request, via proxy computing system 102.

Each of client computing system 104 through 108 may be configured to run an application software that enables the client computing systems to communicate with proxy computing system 102. The application software may include a development environment that allows a software developer to develop programs that run one or more inference requests on any combination of PUs 128 through 140, or on simulated processing units 142. Proxy computing system 102 may function as an intermediary between client computing systems 104 through 108, PUs 128 through 140, and simulated processing units 142. Proxy computing system 102 may route model loading (fulfillment of model load requests) and inference requests to any selected of combination PUs 128 through 140, and route inference results, statistics results, and other data back to client computing systems 104 through 108. Any number of client computing systems and PUs can be supported by embodiments of proxy computing system 102.

As an example, proxy computing system 102 may be associated with deploying artificial intelligence algorithms to run on one or more neural network models instantiated/loaded on any combination of PUs 128 through 140. These artificial intelligence algorithms may be associated with machine vision applications, such as inferencing, object detection, object identification, object tracking, etc.

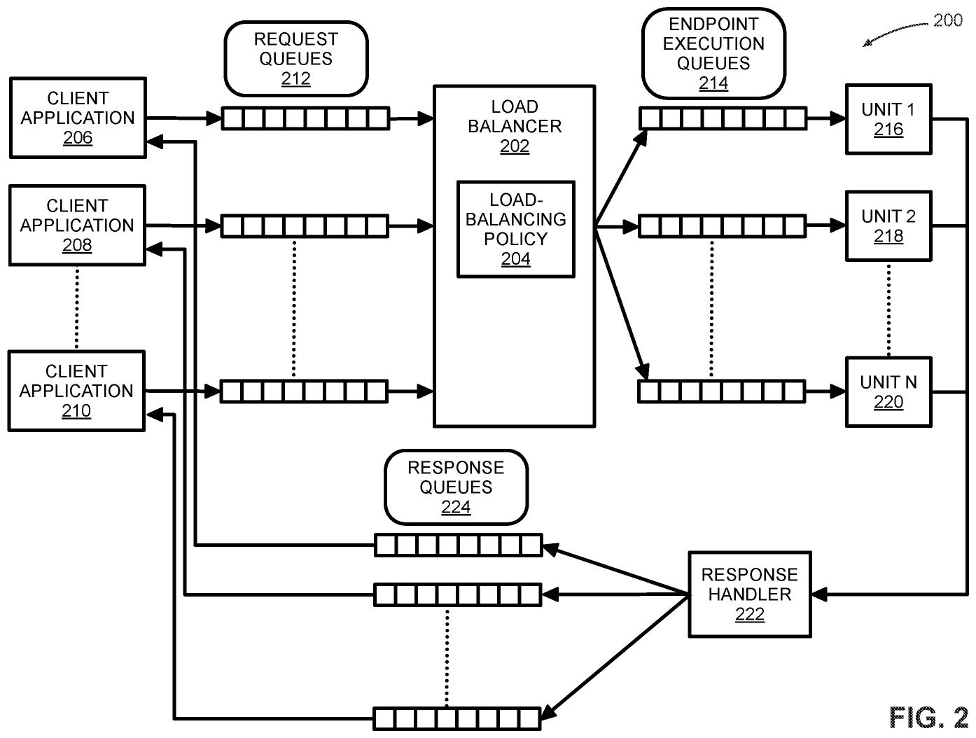

FIG. 2 is a block diagram depicting a request management workflow 200 by proxy computing system 102. Request management workflow 200 may be associated with proxy computing system 102 receiving one or more inferencing requests from client computing systems 104 through 108. In one aspect, each of client computing system 104 through 108 runs a client application. For example, client computing system 104 may run client application 206, client computing system 106 may run client application 208 and so on, through client computing system 108 running client application 210.

Inference requests generated by each client application may be generated as request queues 212. Each of client application 206 through 210 may generate its own request queue. Request queues 212 may be received by load balancer 202, running load balancing policy 204. Load balancer 202 may be implemented as a component of proxy computing system 102. Load balancing policy 204 may determine a load state of PUs unit 1 206, unit 2 218, through unit N 220. PUs unit 1 216 through unit N 220 may be similar to PUs 128 through 140.

Based on the load states, load-balancing policy 204 may assign and route the request queues in request queues 212 as endpoint execution queues 214. In an aspect, endpoint execution queues 214 are created based on individual load states (e.g., available resources) on each of unit 1 216 through unit N 220. Endpoint execution queues 214 may include requests such as inference requests to be run on appropriate neural network models instantiated on each of unit 1 216 through unit N 220.

In an aspect, as unit 1 216 through unit N 220 complete the execution of respective endpoint execution queues, each PU produces an inference output (i.e., an inference response) and transmits the inference output to response handler 222. Response handler 222 allocates inference responses from unit 1 216 through unit N 220 into response queues 224. The response queues 224 are constructed by responses handler 222 such that the respective inference responses are routed back to the appropriate client application in client application 206 through client application 210. In an aspect, a response queue is a set of inference responses to be routed to a specific client application.

As an example, a request queue including an inference request from client application 206 may be routed as an endpoint execution queue to unit 2 218. Unit 2 218 may execute the inference request and generate an inference response. Response handler 222 may receive this inference response and add this inference response to a response queue to be routed back to client application 206.

By dynamically assigning processing units based on load state to appropriate inference requests, proxy computing system 102 provides a flexible operating environment that reduces system throughput slowdowns (e.g., bottlenecks).

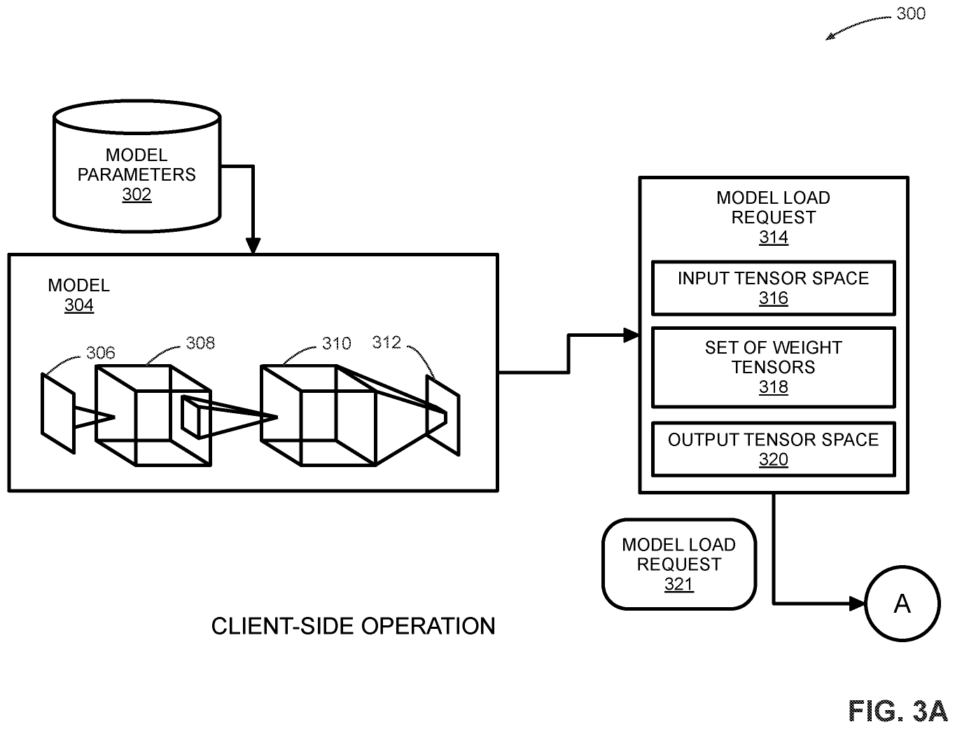

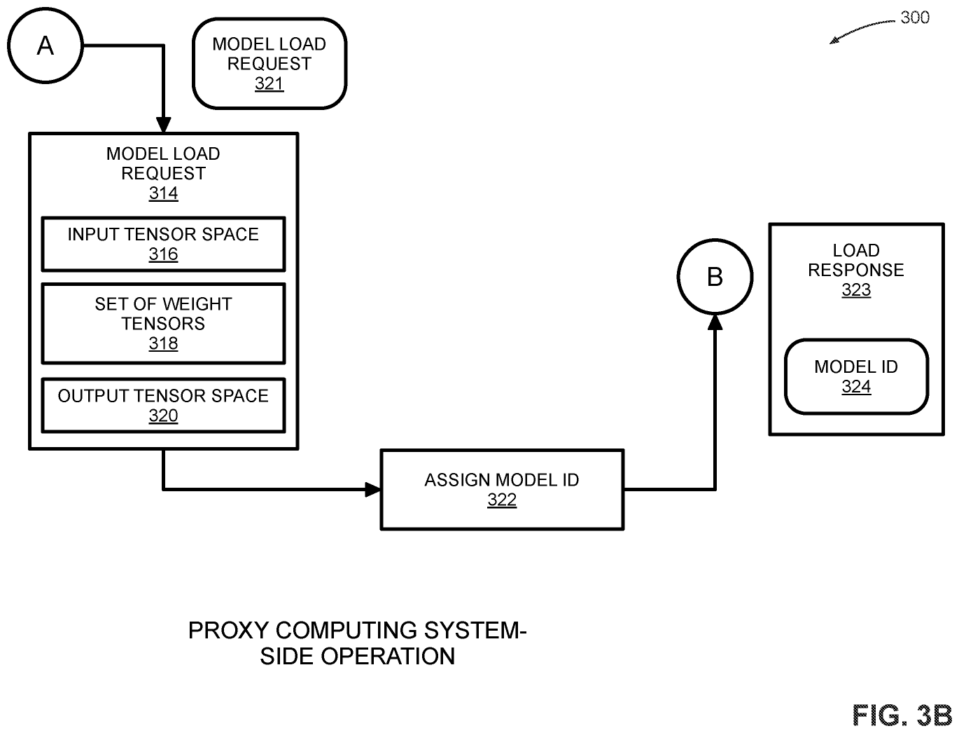

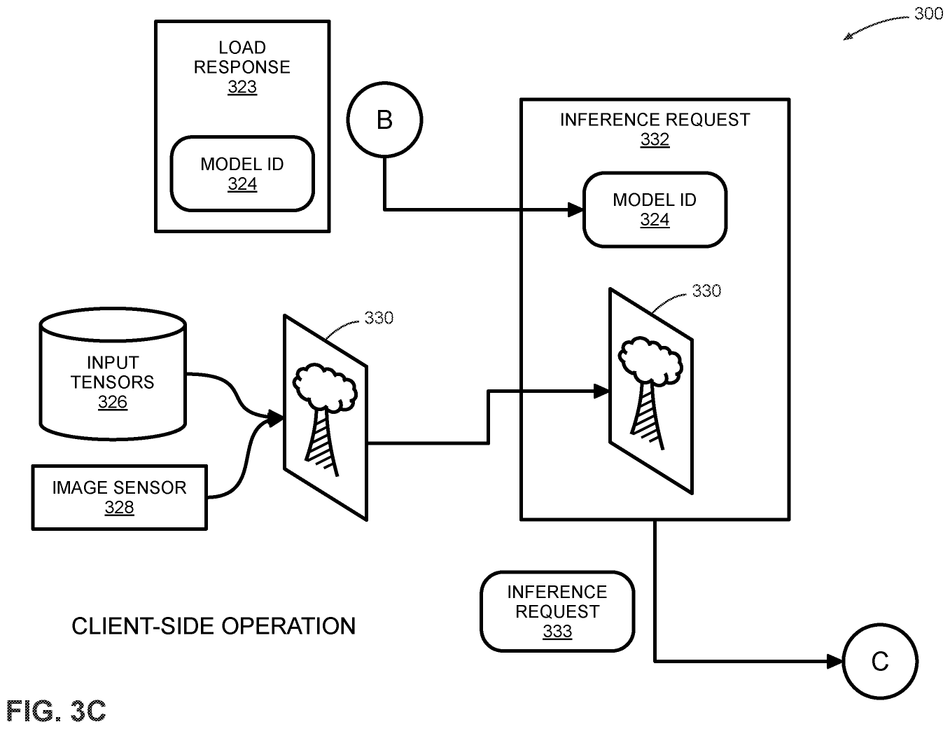

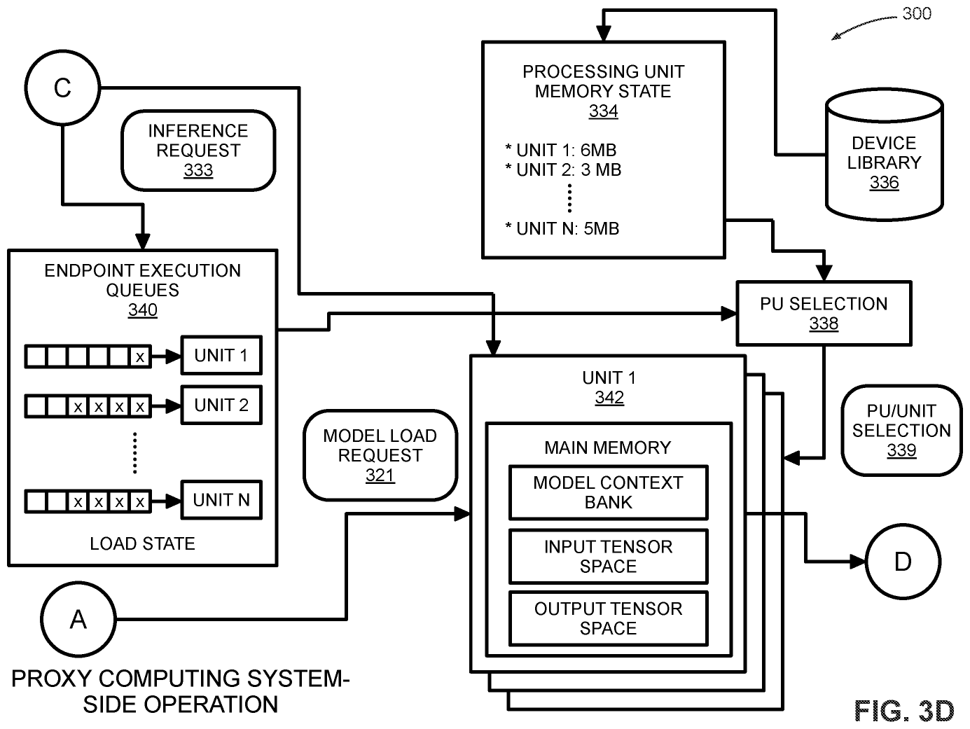

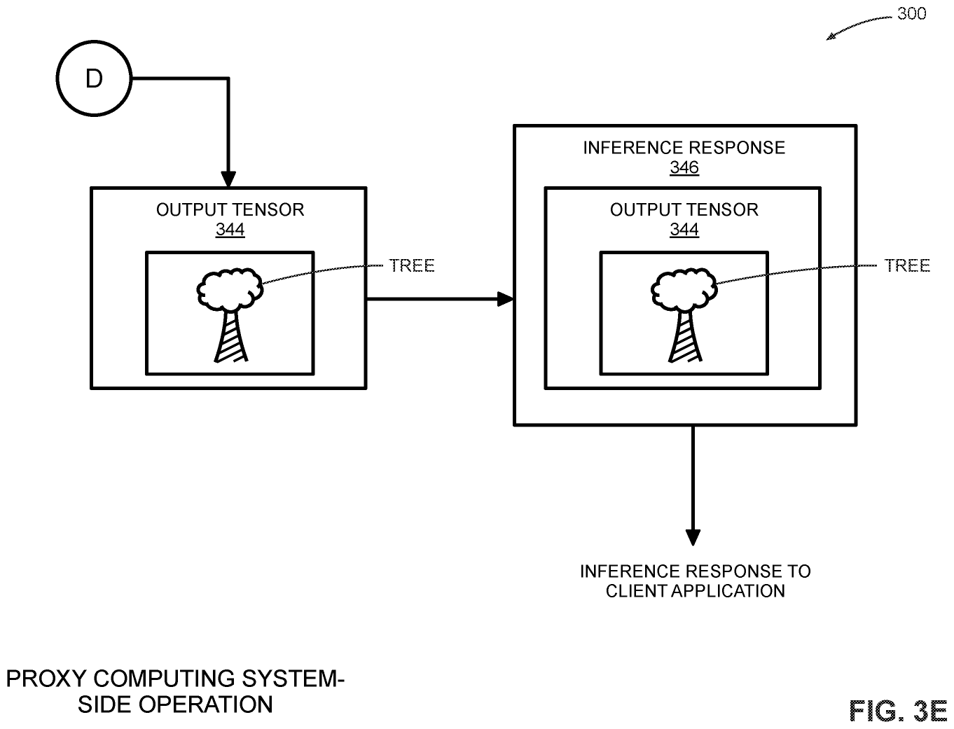

FIGS. 3A, 3B, 3C, 3D, and 3E are block diagrams depicting an inference request/response workflow 300.

FIG. 3A depicts a client computing system-side operation, where a model 304 may be retrieved from a model parameters database 302, by a client computing system such as client computing system 104. Model 304 may be a neural network model. In an aspect, model 304 may include input tensor space 306 (e.g., an image or a video frame), and sets of weight tensors 308 and 310. Input tensor stage 306 may be combined with weight tensors 308 and 310 (e.g., via a weighting operation) to generate output tensor space 312. Collectively, input tensor space 306, weight tensors 308 and 310, and output tensor space 312 may be included in a definition of model 304.

In an aspect, the client computing system may generate model load request 314 comprising input tensor space 316 (e.g., input tensor space 306), set of weight tensors 318 (e.g., weight tensors 308 and 310), and output tensor space 320 (e.g., output tensor space 310). This model load request 314 may be transmitted to proxy computing system as model load request package 321.

As depicted in FIG. 3B, proxy computing system 102 receives the model load request package 321, and assigns a model ID (process 322) to model load request 314. Proxy computing system may also load the associated neural network model onto a selected PU (e.g., PU 128) depending on PU computing load and available resources. Proxy computing system 102 may send a load response 323 back to the client computing system. Load response 323 may include model ID 324 associated with a specific neural network model.

As depicted in FIG. 3C, the client computing system receives load response 323 and constructs inference request 332 that includes model ID 324. The client computing system may also construct input tensor 330 based on inputs received from any combination of input tensors database 326 and image sensor 328. In an aspect, input tensors database 326 includes one or more images or sequences of video frames. Image sensor 328 may be a camera sensor that generates an image or a sequence of video frames. Input tensor 330 may be included in inference request 332 by the client computing system. The client computing system may send inference request 332 as inference request package 333 to proxy computing system 102.

As depicted in FIG. 3D, proxy computing system 102 receives model load request package 321. In response, as a part of model ID assignment process 322, proxy computing system 102 may access processing unit memory state 334 from device library 336 (similar to device library 122). For example, unit 1 216 may have 6 MB of memory available; unit 2 218 may have 3 MB of memory available, and so on, till unit N 220 having 5 MB of memory available. Based on processing unit memory state 334, PU selection 338 may select one or more PUs (e.g., unit 1 and other PUs) to load the model on, as PU/unit selection 339. This selection of PUs may be referred to as a subset of PUs. The loaded model may be a neural network model corresponding to model ID 324.

Subsequently, when proxy computing system 102 receives inference request package 333, PU selection 338 may access one or more endpoint execution queues associated with the subset of PUs. Endpoint execution queues 340 may be analyzed along with a load state of each PU in the subset. Based on the analysis, proxy computing system may select a target PU (e.g., unit 1 342) for executing inference request 332. Inference request 332 included in inference request package 333 may be routed to unit 1 342. In this case, a model context bank, an input tensor space (corresponding to input tensor space 316), and an output tensor space (corresponding to output tensor space 320) may be written to a main memory portion of unit 1 342. Unit 1 342 may process the inference request, and output an output tensor 344 as depicted in FIG. 3E. Output tensor 344 may include an inference from a neural network model loaded on unit 1 342 (inference—“tree”). This neural network model may correspond to model ID 324. Output tensor 344 may be included in an inference response 346 and transmitted back to the client computing system that originated model load request package 321 and inference request package 333.

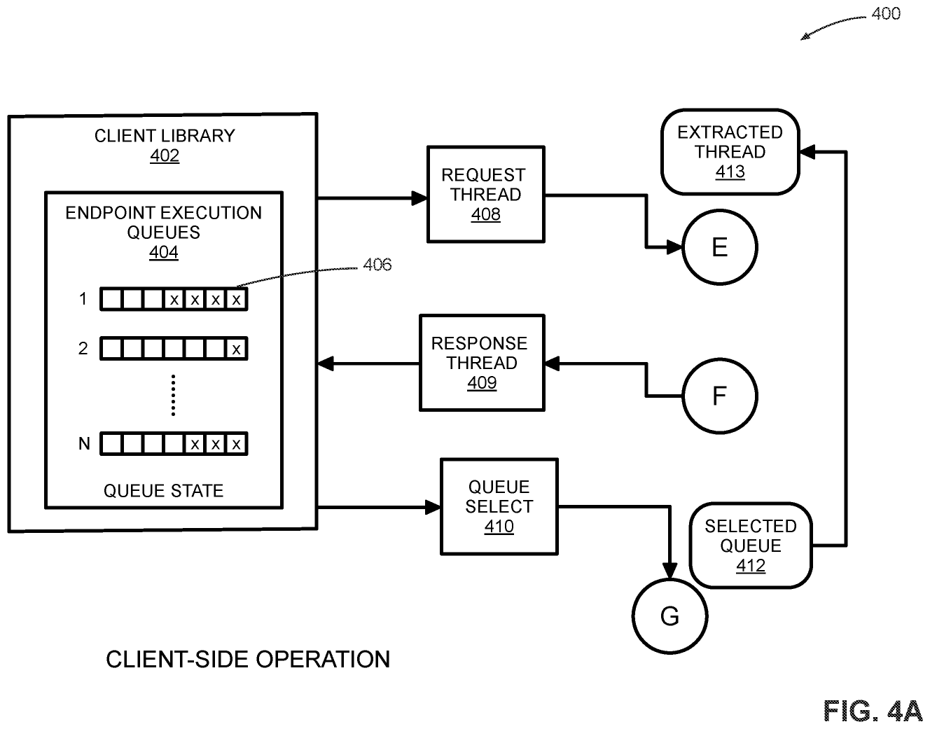

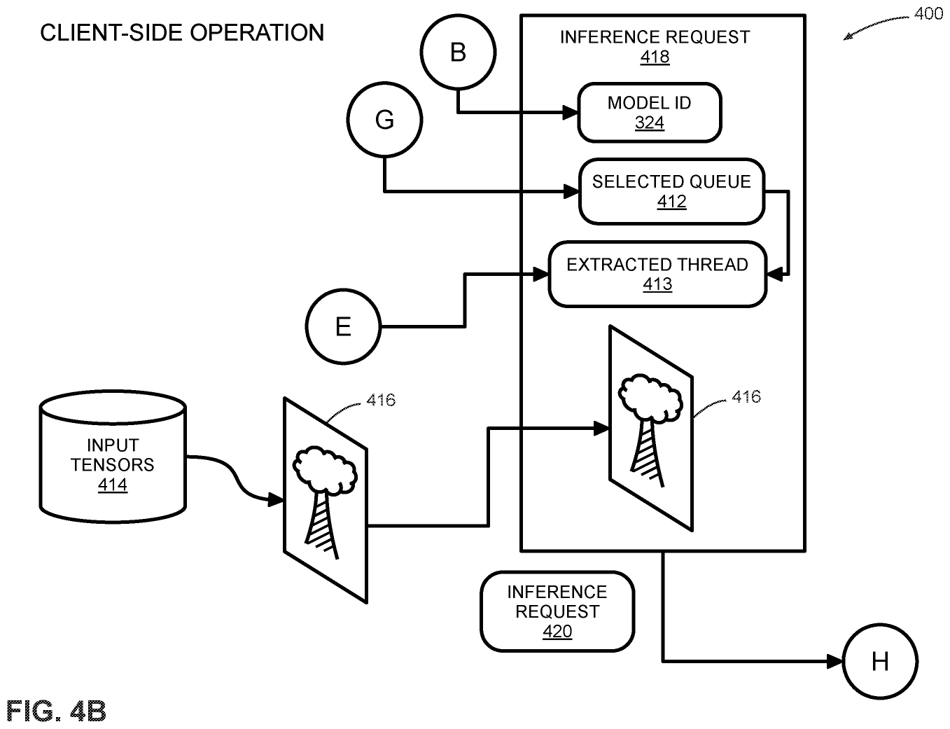

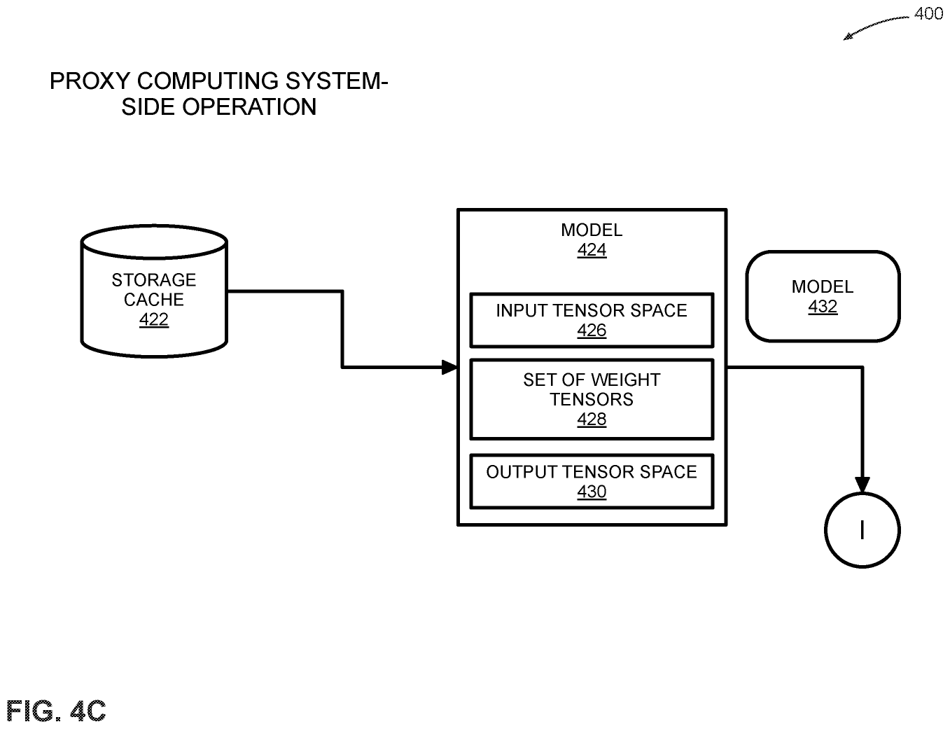

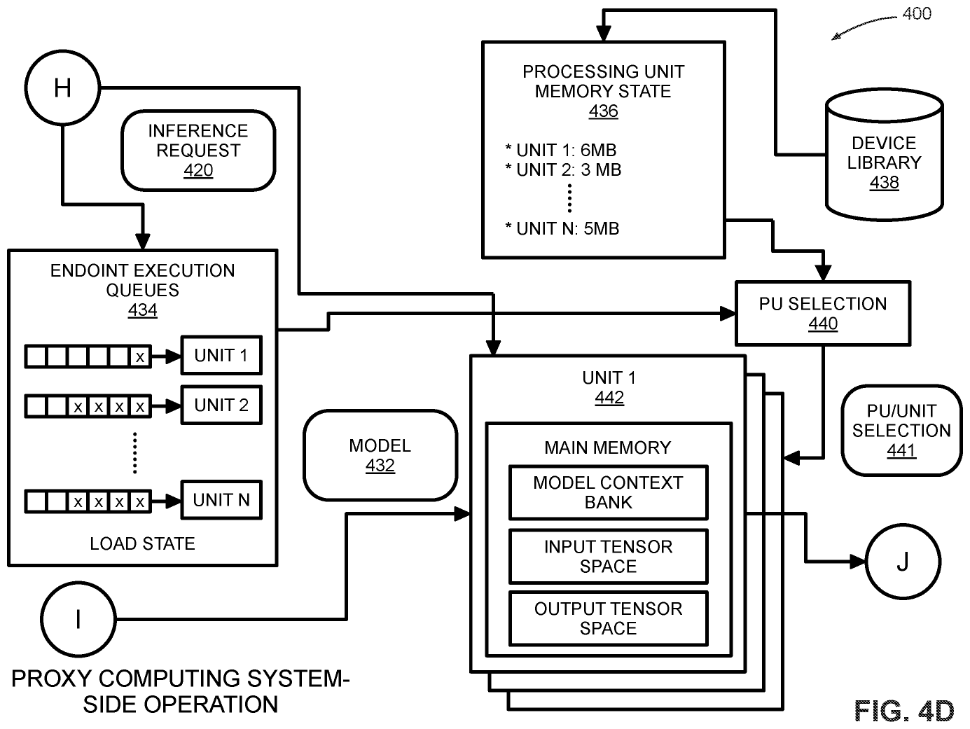

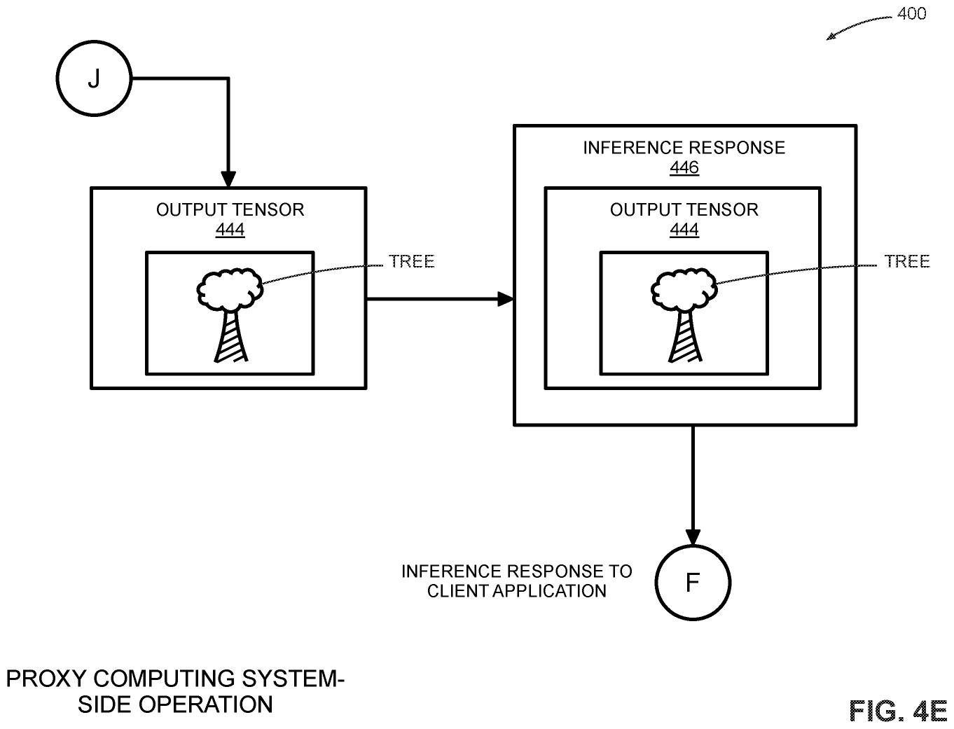

FIGS. 4A, 4B, 4C, 4D, and 4E are block diagrams depicting an inference request/response workflow 400.

FIG. 4A depicts a client computing system-side operation, where one or more endpoint execution queues 404 are stored in client library 402. Endpoint execution queues 404 may include one or more end point execution queues associated with one or more PUs. For example, endpoint execution queue 406 may be associated with unit 1 216. In each endpoint execution queue in endpoint execution queues 404, an “X” denotes an inference request similar to inference request 332.

In one aspect, the client computing system may issue a request thread 408 based on a queue state associated with endpoint execution queues 404.

Based on a queue state associated with each endpoint execution queue in endpoint execution queue 404, queue select 410 may select a specific endpoint execution queue for an inference request, as selected queue 412. Client library 402 may also receive an inference response from proxy computing system 102 via response thread 409.

In one aspect, when an application (e.g., a client application running on client computing system 104) makes a request, this request is sent to endpoint execution queues 404. In response queue selector 410 may select a queue (i.e., selected queue 412) via an arbitration mechanism. Request thread 408 may extract the request that is present in the selected queue (one of 406 that has been identified by 410). The extracted request may include an extracted thread 413.

As depicted in FIG. 4B, the client computing system generates inference request 418. In an aspect, inference request 418 is comprised of model ID 324 (generated from a previous model load request operation), selected queue 412, extracted thread 413, and input tensor 416 retrieved from input tensors database 414. In an aspect, input tensors database 414 includes one or more images or sequences of video frames. The client computing system may transmit inference request 418 as inference request package 420 to proxy computing system 102.

In one aspect, prior to a client computing system sending any inference request to proxy computing system 102, the client computing system may send a model load request at least once to proxy computing system 102. This model load request triggers a model ID generation at proxy computing system 102. This workflow is similar to the workflow depicted in FIGS. 3A and 3B. After the model ID generation, both proxy computing system 102 and the client computing system can store this model ID (e.g., model ID 324) in memory or storage cache 118, and use the model ID in any subsequent inference requests. At a restart of any of the systems (i.e., proxy computing system 102 and/or client computing systems 104 through 108), the respective storage cache can be used by all systems to retrieve the model ID and use without the need of sending a model load request again.

As depicted in FIG. 4C, proxy computing system 102 may retrieve model 424 from storage cache 422. Model 424 may be a neural network model comprised of input tensor space 426, set of weight tensors 428, and output tensor space 430. Model 424 is output as model data 432.

As depicted in FIG. 4D, proxy computing system 102 receives model data 432 containing model 424. Proxy computing system 102 may load model 424 onto any, all, or one of PUs such as unit 1 442, and other PUs. This selection of PUs may be referred to as a subset of PUs. In an aspect, the subset of PUs is selected via PU selection 440 based on processing unit memory state 436 retrieved from device library 438 (similar to device library 122). For example, unit 1 216 may have 6 MB of memory available; unit 2 218 may have 3 MB of memory available, and so on, till unit N 220 having 5 MB of memory available. Based on processing unit memory state 436, PU selection 440 may select one or more PUs (e.g., unit 1 and other PUs) to load the model on, as PU/unit selection 441.

Proxy computing system 102 may also receive inference request package 420. PU selection 440 may access one or more endpoint execution queues associated with the subset of PUs. Endpoint execution queues 434 may be analyzed along with a load state of each PU in the subset. Based on the analysis, proxy computing system 102 may select a target PU (e.g., unit 1 442) for executing inference request 418. Inference request 418 included in inference request package 420 may be routed to unit 1 442. In this case, a model context bank, an input tensor space, and an output tensor space may be written to a main memory portion of unit 1 442. Unit 1 442 may process the inference request, and output an output tensor 444 as depicted in FIG. 4E. Output tensor 444 may include an inference from a neural network model loaded on unit 1 442 (inference—“tree”). Output tensor 444 may be included in an inference response 446 and transmitted back to the client computing system that originated model inference request package 420. Inference response 446 may be transmitted back to client library 402 via response thread 409.

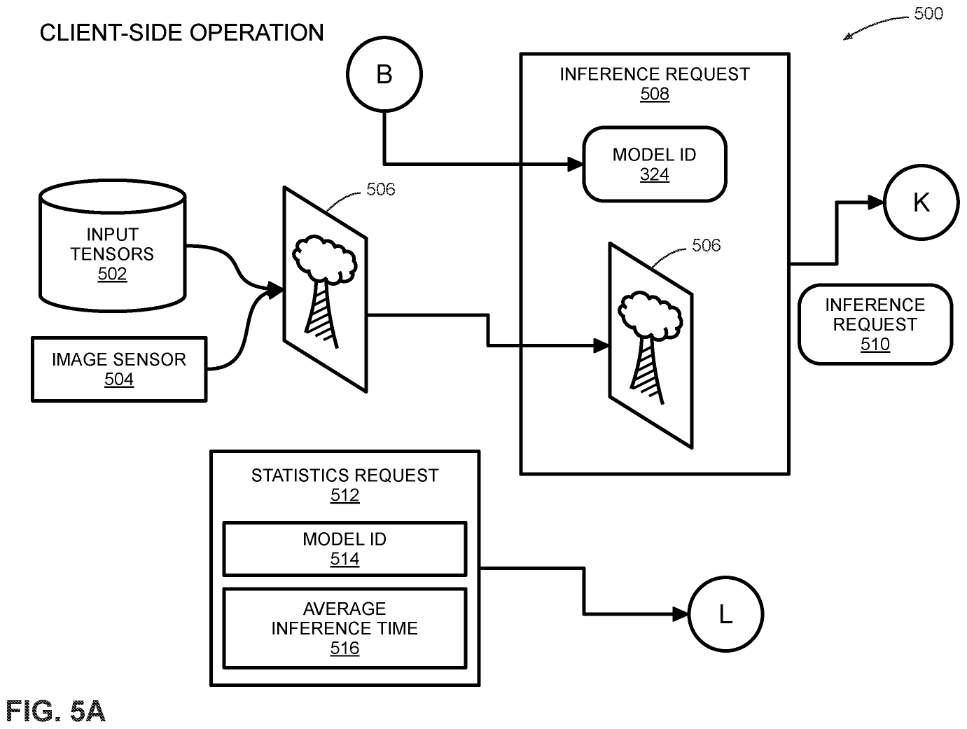

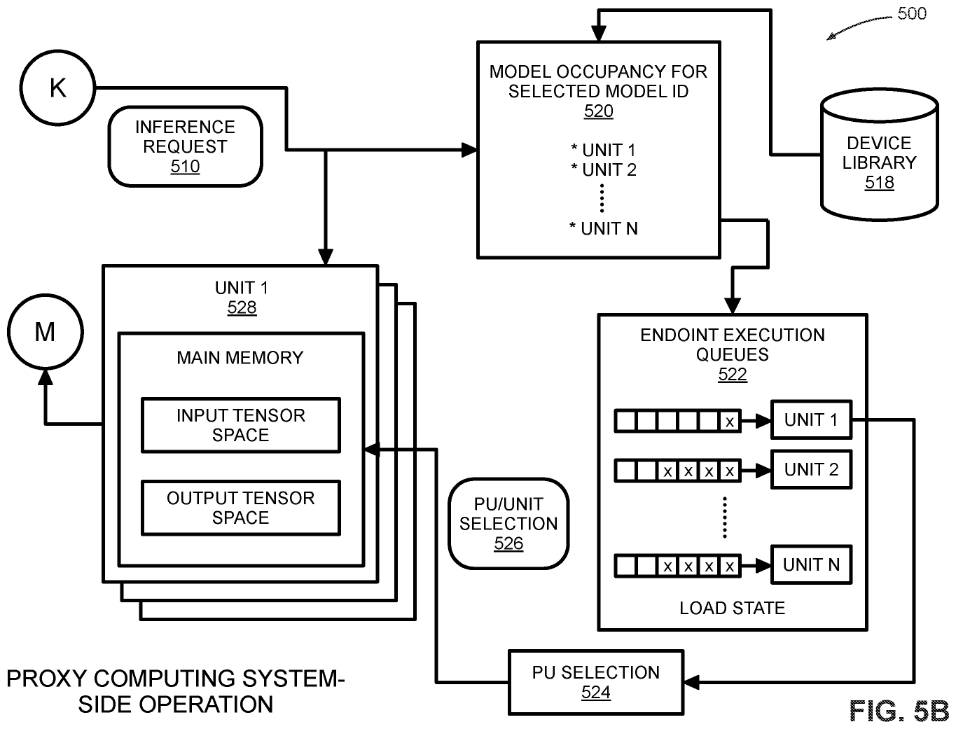

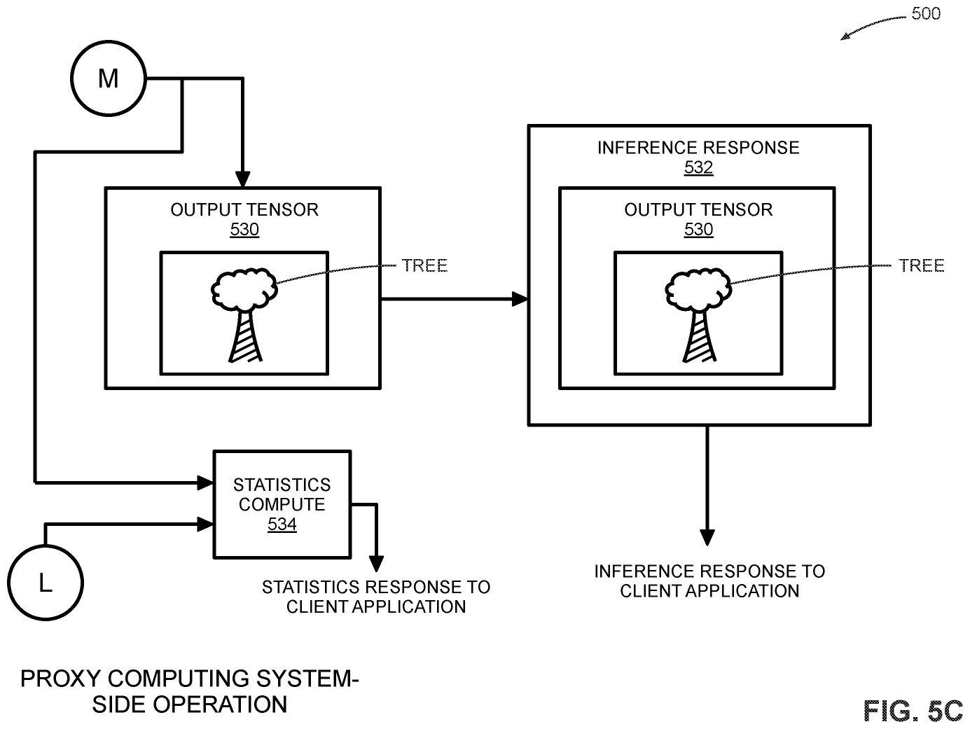

FIGS. 5A, 5B, and 5C are block diagrams depicting an inference request/response workflow 500.

FIG. 5A depicts a client computing system-side operation, where the client computing system constructs inference request 508 that includes model ID 324 generated from a prior model load request. The client computing system may also construct input tensor 506 based on inputs received from any combination of input tensors database 502 and image sensor 504. In an aspect, input tensors database 502 includes one or more images or sequences of video frames. Image sensor 504 may be a camera sensor that generates an image or a sequence of video frames. Input tensor 506 may be included in inference request 508 by the client computing system. The client computing system may send inference request 508 as inference request package 510 to proxy computing system 102.

The client computing system may also generate a statistics request 512, the statistics request 512 including model ID 514, and average inference time 516. Statistics request 512 may also be transmitted by the client computing system to proxy computing system 102.

FIG. 5B depicts a proxy computing system-side operation, where proxy computing system 102 processes inference request package 510. In response to receiving inference request 501, proxy computing system 102 may access model occupancy for selected model ID 520 from device library 518 (similar to device library 122). Model occupancy for selected model ID 520 may provide a listing of one or more PUs (e.g., unit 1 216, unit 2 218, and so on) that are loaded with a neural network model associated with model ID 324. Data from model occupancy for selected model ID 520 may be used by proxy computing system 102 to select a subset of PUs that are loaded with the neural network model associated with model ID 324.

In one aspect, proxy computing system 102 may access a set of endpoint execution queues 522 associated with the subset of PUs that are loaded with the neural network model associated with model ID 324. Based on a load state of each PU as indicated by endpoint execution queues 522, PU selection 524 may perform PU/unit selection 526, to select one or more target PUs from the subset to run inference request 508. To run inference request 508, a main memory of each PU (e.g., unit 1 528) may be loaded with an input tensor space and an output tensor space associated with inference request 508.

FIG. 5C depicts a proxy computing system-side operation, where one or more PUs run inference request 508, to produce output tensor 530. Output tensor 530 may include an inference from a neural network model loaded on unit 1 528 (inference—“tree”). Output tensor 530 may be included in an inference response 532 and transmitted back to the client computing system that originated model inference request package 510.

In one aspect, proxy computing system 102 may process statistics request 512 for model ID 514, to determine average inference time 516. In one aspect, model ID 514 is identical to model ID 324. Statistics compute 534 may process statistics request 512 based on proxy computing system monitoring an execution of the inference request by the target processing device based on the neural network model. Statistic compute 534 may generate a response to statistics request 512 (including an average inference time) and transmit the response to a client application running on the client computing system.

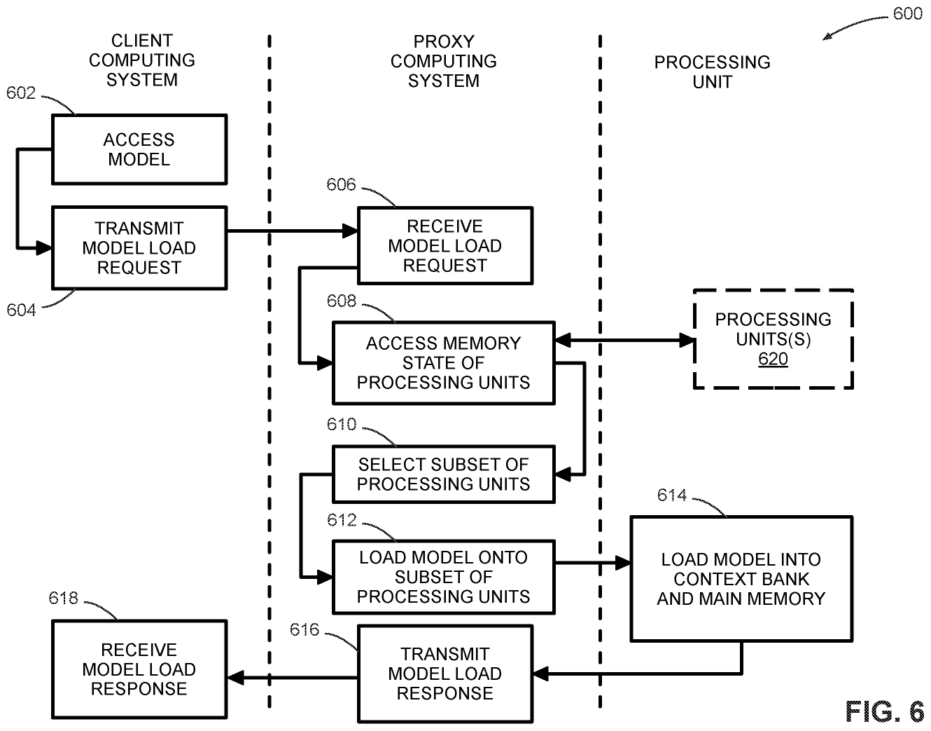

FIG. 6 is a workflow diagram depicting a workflow 600 for generating a model load response. Workflow 600 may be implemented on any combination of proxy computing system 102 and client computing systems 104 through 108.

Workflow 600 may include a client computing system accessing a model (602). For example, a client computing system may access model 304 from model parameters database 302. Workflow 600 may include transmitting a model load request associated with the model by the client computing system to proxy computing system 102. For example, the client computing system may transmit model load request 314 as model load request package 321 to proxy computing system 102.

Workflow 600 may include the proxy computing system (e.g., proxy computing system 102) receiving the model load request (606). For example, proxy computing system may receive model load request 314 via model load request package 321. Workflow 600 may include proxy computing system 102 accessing a memory state of each of one or more processing units 620 (608). For example, proxy computing system 102 may access processing unit memory state 334 from device library 336.

Workflow 600 may include proxy computing system 102 selecting a subset of processing units (610). For example, PU selection 338 and PU/unit selection 339 process may select the subset of processing units (e.g., unit 1 342). Workflow 600 may include proxy computing system 102 loading the model (e.g., a neural network model associated with model ID 324) onto the subset of processing units (612).

Workflow 600 may include the subset of processing systems loading the model into an associated context bank and main memory (614). For example, unit 1 342 may include a model context bank in main memory that loads the neural network model corresponding to model ID 324.

Workflow 600 may include proxy computing system 102 transmitting the model load response to the client computing system (616), and the client computing system receiving the model load response (618). For example, proxy computing system 102 may transmit load response 323 to the client computing system that originated the model load request.

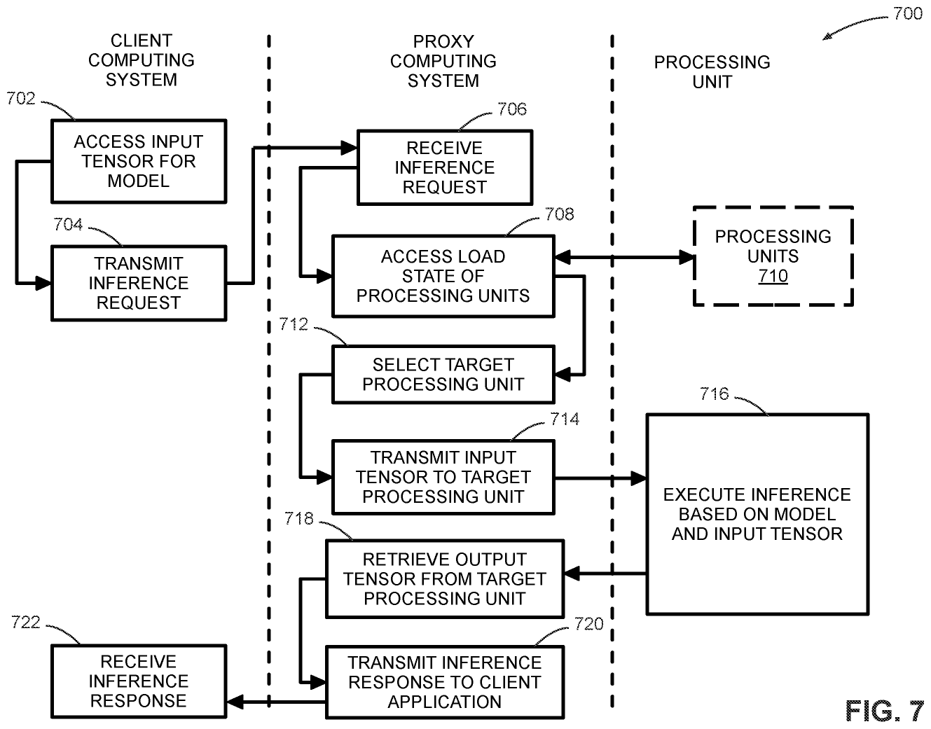

FIG. 7 is a workflow diagram depicting a workflow 700 for generating an inference response.

Workflow 700 may include a client computing system accessing an input tensor for a neural network model (702). For example, any of client computing systems 104 through 108 may access input tensors from input tensors database 326, or from image sensor 328.

Workflow 700 may include the client computing system transmitting an inference request associated with the input tensors to proxy computing system 102 (704). For example, the client computing system transmits inference request 332 as inference request package 333 to proxy computing system 102. Workflow 700 may include proxy computing system receiving the inference request (706), and accessing a load state of each PU in a set of PUs (708). For example, proxy computing system 102 may receive inference request package 333 and access a load state associated with endpoint execution queues 340. Endpoint execution queues may correspond to processing unit(s) 710, which may be similar to unit 1 216/342, unit 2 218, through unit N 220.

Workflow 700 may include proxy computing system 102 selecting a target processing unit (712). For example, PU selection 338 associated with proxy computing system 102 may select a target processing unit (e.g., unit 1 342) for executing inference request 332. Workflow 700 may include proxy computing system 104 transmitting an input tensor to the target processing unit (714). For example, proxy computing system 104 may transmit inference request 332 including input tensor 330 to unit 1 342 for inferencing.

Workflow 700 may include executing the inference based on a neural network model and an input tensor (716). For example, unit 1 342 may execute inference request 332 based on input tensor 330 and model ID 324. Unit 1 342 may also generate an output tensor as a result of the inference request execution (e.g., output tensor 344, with an inference result such as “tree”). Workflow 700 may include proxy computing system 102 retrieving the output tensor from the target processing unit (718). For example, proxy system may retrieve output tensor 344 from unit 1 342.

Workflow 700 may include proxy computing system 102 transmitting an inference response to a client application running on the client computing system (720). For example, proxy computing system 102 may construct inference response 346 including output tensor 344 and transmit the inference response 346 to the client computing system. Workflow 700 may include the client computing system receiving the inference response from proxy computing system 102 (722).

In one aspect, a process of inferencing includes running an artificial intelligence (AI) algorithm on an input tensor sourced from an image or video file. Proxy computing system 102 may be configured to map one or more client computing systems 104 through 108 to one or more PUs 128 through 140. Each of client computing system 104 through 108 may be a remote computing system or a local computing system. Client computing systems 104 through 108 may be interfaced with proxy computing system 102 via communication protocols such as TCP/IP or other networking protocols.

In one aspect, request manager 116 performs a function of load balancing between PUs 128 through 140. Request manager 116 may also account aspects such as for fault tolerance, device monitoring, device failure, etc.

In general, any inference operation requires at least one AI/neural network model. AI models are generally bulky with respect to computing resources. A fault or crash in network of client computing systems and PUs may result in significant delays as these AI models may need to be reloaded into device memory during system recovery. In one aspect, proxy computing system 102 maintains model library 120 in storage cache 118. If there is any fault or crash, proxy computing system 102 can access the appropriate AI/neural network model in storage cache 118 to expedite bringing back all systems online.

In an aspect, proxy computing system 102 may allow virtually seamless (from the perspective of client computing systems 104 through 108) between different neural network models. Each neural network model may be associated with a unique model ID. Based on different inference requests from different client computing systems, different neural network models can be interchangeably loaded onto any combination of PUs 128 through 140.

In one aspect, an API running on a client computing system (e.g., client computing system 104) can talk directly to a PU (e.g., PU 128), or via proxy computing system 102. In this sense, proxy computing system 102 may function as a device driver. However, while a typical device driver is limited to a single interface (USB or PCIe), proxy computing system 102 implements a unified interface that supports multiple interface protocols simultaneously, including multiple instances of an identical protocol (e.g., PCIe 110 and USB 112 being connected to multiple PUs simultaneously). An end user does not need to care about how such connectivity happens; the connectivity process is transparently implemented by proxy computing system 102.

Proxy computing system may also perform the following functions:
Cycle stealing during inferencing to perform other tasks
Provisioning memory before time for an inference request
Resource management/allocation and load balancing
Model management
Device management including fault handling (inference workloads)
Thread management

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving a neural network model from a client computing system;
assessing system resource availability on a plurality of processing devices;
selecting a subset of available processing devices based on the system resource availability;
loading the neural network model into each processing device in the subset;
receiving an inference request from the client computing system;
accessing a load state of each processing device in the subset;
selecting a target processing device from the subset based on the load states; and
transmitting the inference request to the target processing device.

2. The method of claim 1, further comprising:
receiving an inference result generated by the target processing device after executing the inference request based on the neural network model; and
transmitting the inference result to the client computing system.

3. The method of claim 2, wherein the inference result is an output tensor.

4. The method of claim 1, wherein the neural network is a convolutional neural network or a neural network comprised of one or more linear algebra operators.

5. The method of claim 1, further comprising automatically determining and negotiating a type of processing device interface associated with a processing device.

6. The method of claim 5, wherein the processing device interface is any of a PCIe bus interface, a USB interface, or an IPC interface.

7. The method of claim 1, wherein the inference request includes an input tensor.

8. The method of claim 7, wherein the input tensor is an image generated by an image sensor.

9. The method of claim 1, further comprising selecting the subset based on analyzing a processing unit memory state of each of the plurality of processing devices.

10. The method of claim 1, further comprising assigning a model ID to the neural network model.

11. An apparatus comprising:
a proxy computing system;
a client computing system communicatively coupled to the proxy computing system; and
a plurality of processing devices communicatively coupled to the proxy computing system, wherein:
the proxy computing system receives a neural network model from the client computing system;
the proxy computing system assesses system resource availability on the processing devices;
the proxy computing system selects a subset of available processing devices based on the system resource availability;
the proxy computing system loads the neural network model into each processing device in the subset;
the proxy computing system receives an inference request from the client computing system;
the proxy computing system accesses a load state of each processing device in the subset;
the proxy computing system selects a target processing device from the subset based on the load states;
the proxy computing system transmits the inference request to the target processing device; and
the target processing device executes the inference request based on the neural network model.

12. The apparatus of claim 11, wherein:
the target processing device generates an inference result based on the execution;
the target processing device transmits the inference result to the proxy computing system; and
the proxy computing system transmits the inference result to the client computing system.

13. The apparatus of claim 12, wherein the inference result is an output tensor.

14. The apparatus of claim 11, wherein the neural network is a convolutional neural network or a neural network comprised of one or more linear algebra operators.

15. The apparatus of claim 11, wherein a processing device in the plurality of processing devices is communicatively coupled to the proxy computing system via a processing device interface, and wherein the proxy computing system automatically determines and negotiates the type of the processing device interface.

16. The apparatus of claim 15, wherein the processing device interface is any of a PCIe bus interface, a USB interface, or an IPC interface.

17. The apparatus of claim 11, wherein the inference request includes an input tensor.

18. The apparatus of claim 17, wherein the input tensor is an image generated by an image sensor.

19. The apparatus of claim 11, wherein the subset is selected based on analyzing a processing unit memory state of each of the plurality of processing devices.

20. The apparatus of claim 11, wherein the proxy computing system assigns a model ID to the neural network model.
